(19) United States
(12) Patent Application Publication
(10) Pub. No.: US 2011/0068747 A1
(43) Pub. Date: Mar. 24, 2011

(54) CYCLIC SELF-MAINTENANCE BATTERY DEVICE

(76) Inventor: Lan-Rong DUNG, Sindian City (TW)

(21) Appl. No.: 12/564,382

(22) Filed: Sep. 22, 2009

(51) Int. Cl. H02J 7/00

(52) U.S. Cl. 320/132

(57) ABSTRACT

The present invention relates to a cyclic self-maintenance battery device, which describes a self-maintenance battery device that can be coupled to batteries, and the batteries are coupled to a load, The self-maintenance battery device comprises a charger module, an electric discharge module, a control module and a SOH (State of Health) indication, wherein the control module assigns the batteries to be in standby state, charging mode or discharging mode. Accordingly, the present invention can continuously charge, discharge the batteries, and thus prevent an AC (alternating current) power from continuous charging the batteries for long periods of time causing problems of battery degradation, thereby prolonging the serviceable life of the batteries, reducing the number of times the batteries need to be replaced, and further achieving the environmental protection objective.

### BACKGROUND OF THE INVENTION

(a) Field of the Invention

The present invention provides a device for self-maintenance and activation of secondary batteries, and more particularly provides a device whereby N secondary batteries within a power supply system consisting of M secondary batteries are assigned to supply power or are placed in the standby state to supply the electric power required by external loads. Moreover, the other (M-N) secondary batteries are discharged in turn using a cyclic method, thereby enabling carrying out self-maintenance and upkeep, and achieving the objective of activating the secondary batteries. Accordingly, the present invention is able to prolong the serviceable life of secondary batteries, reduces the number of times the batteries need to be replaced, and further achieves an environmental protection objective.

(b) Description of the Prior Art

The interior of an emergency illuminating lamp or spare battery system, for example: a UPS (Uninterruptible Power Supply), and the like, generally includes secondary batteries that can be charged and reused, and is installed with a power failure detection control module. The control module enables detecting whether the current main power supply is normal or not, and if the current main power supply is abnormal, then the supply of electric power is changed over to the internal batteries. Hence, unless a power failure problem occurs, otherwise equipment such as an emergency illuminating lamp or power failure power supply is in a power supply standby state for extended periods of time, and because the internal secondary batteries are in a fully charged state for extended periods of time, thus degradation of the secondary batteries easily results, which decreases the serviceable life thereof.

However, the following problems and shortcomings are still in need of improvement when using the aforementioned emergency illuminating lamp or UPS of the prior art:

Because the batteries in the interior of an emergency illuminating lamp or a UPS are connected to an AC (alternating current) power supply for long periods of time, thus, the batteries are maintained in charging mode or fully charged state for extended periods of time. And because the batteries in such states seldom have the opportunity to undergo discharging, thus, the opportunity to activate the batteries is also reduced, which easily results in a degradation effect of the batteries. Accordingly, normally in less than one year, the secondary batteries are unable to further properly supply power, and instead, in an emergency situation, the batteries in the interior of the emergency illuminating lamp or UPS are frequently unable to properly supply power because the batteries are already too degraded.

### SUMMARY OF THE INVENTION

The main objective of the present invention lies in providing a mechanism to enable charging and discharging activation of secondary batteries at regular intervals using an automatic cyclic means without affecting the objective of supplying standby power, thereby enabling prolonging the serviceable life of the batteries. Moreover, such a mechanism enabling automatic cyclic activation of secondary batteries is named a “cyclic self-maintenance battery device”.

In order to achieve the aforementioned objective, a self-maintenance battery device of the present invention is coupled to batteries, and the batteries are coupled to a load. The self-maintenance battery device comprises a charger module, an electric discharge module, a control module and a the SOH (State of Health) indication, wherein the charger module enables charging of the batteries; the electric discharge module enables discharging of the batteries; and the control module enables assigning the batteries to be in standby state, charging mode or discharging mode. When the batteries are in standby state, then the batteries are coupled to the load and provide electric power to the load. When the batteries are in charging mode, then the batteries are coupled to the charger module, and the charger module is used to charge the batteries. When the batteries are in discharging mode, then the batteries are coupled to the electric discharge module, and the electric discharge module is used to discharge the batteries. The SOH indication enables recording and tracing conditions in the change of voltage of during charging and discharging of the batteries, thereby enabling the serviceable life of the batteries to be evaluated, and indicate a battery replacement caution at the appropriate time to remind users. The control module included in the present invention enables assigning the batteries to be in standby state, charging mode or discharging mode, and the assignment mode is based on the battery maintenance history, whereby the batteries requiring maintenance are selected at regular intervals for upkeep thereof. When the batteries are in standby state, then the batteries are coupled to a load and provide electric power to the load, this being the general use mode.

When the batteries are in charging mode, then the batteries are coupled to the charger module, and the charger module is used to charge the batteries, this being the mode when the batteries have been drained of power, and activation of the batteries with electric power is carried out. When the batteries are in discharging mode, then the batteries are coupled to the electric discharge module, and the electric discharge module is used to discharge the batteries, this being a maintenance operation mode of the batteries. Accordingly, use of the aforementioned mechanism enables improving the problems of easy degradation of secondary batteries when connected to an AC power supply for long periods of time undergoing continuous charging. The present invention uses the control module to cyclic assign batteries to be in charging or discharging modes to activate the batteries, thereby prolonging the serviceable life of the batteries, and achieving an environmental protection objective.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 is a block diagram of a preferred embodiment of the present invention.

FIG. 2 is a first implementation schematic view of the preferred embodiment according to the present invention.

FIG. 3 is a second implementation schematic view of the preferred embodiment according to the present invention.

FIG. 4 is a third implementation schematic view of the preferred embodiment according to the present invention.

FIG. 5 is a first implementation schematic view of another preferred embodiment according to the present invention.

FIG. 6 is a second implementation schematic view of the other preferred embodiment according to the present invention.

### DETAILED DESCRIPTION OF THE PREFERRED EMBODIMENTS

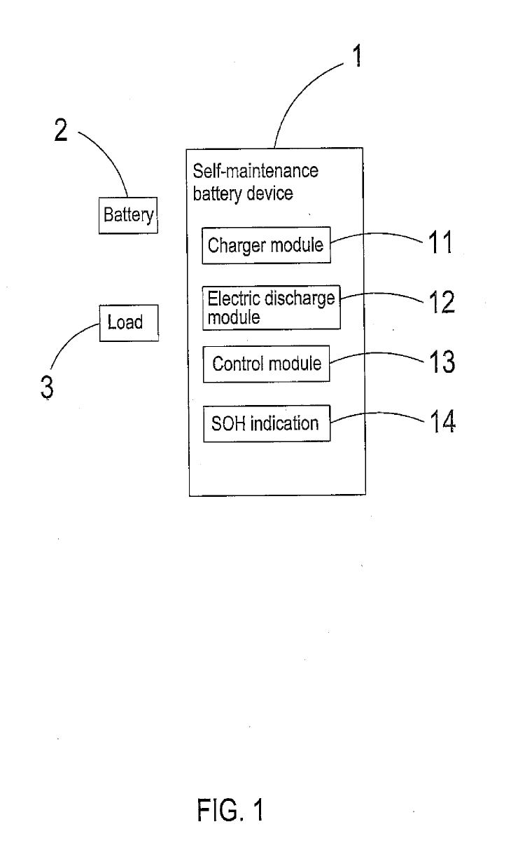

Referring to FIG. 1, which shows a block diagram of a preferred embodiment of the present invention, and it can be clearly seen from the drawing that a self-maintenance battery device 1 of the present invention can be coupled to at least one battery 2, and the battery 2 can be either a nickel-hydrogen battery or a lithium battery or other related secondary battery. The battery is coupled to a load 3, and the load 3 can be an emergency illuminating lamp, a UPS (Uninterruptible Power Supply) or a battery charger or other related loads that must be connected to an AC (alternating current) power supply for long periods of time. The self-maintenance battery device 1 comprises:

A charger module 11, and the charger module 11 enables charging the battery 2.

An electric discharge module 12, and the electric discharge module 12 enables discharging the battery 2.

A control module 13, and the control module 13 enables assigning the battery 2 to be in a standby state, a charging mode or a discharging mode. When the battery 2 is in a standby state, then the battery 2 is coupled to the load 3 and provides electric power to the load 3. When the battery 2 is in a charging mode, then the battery 2 is coupled to the charger module 11, and the charger module 11 is used to charge the battery 2. When the battery 2 is in a discharging mode, then the battery 2 is coupled to the electric discharge module 12, and the electric discharge module 12 is used to discharge the battery 2.

A SOH indication 14, and the SOH indication 14 enables detecting the current state of health of the battery 2, and records and traces conditions in the change of voltage of the battery 2 when charging and discharging, thereby evaluating the serviceable life of the battery, for example: excessive degradation of the battery 2, unserviceability of the battery 2, breakdown of the battery 2, and so on. The SOH indication 14 is able to emit a caution at the appropriate time to remind the user, and allow the user to seize the opportunity to replace the battery 2.

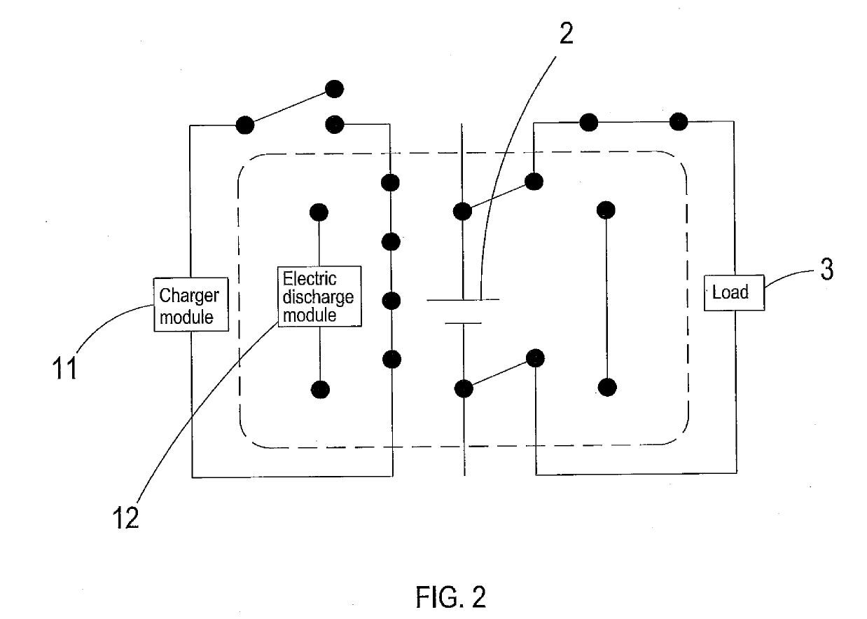

According to the aforementioned structure and constructional design, circumstances during operational use of the present invention are described hereinafter. Referring together to FIG. 1 and FIG. 2, which show the block diagram and a first implementation schematic view respectively of the preferred embodiment of the present invention, and it can be clearly seen from the drawings that the embodiment depicts that the control module 13 of the present invention has assigned the battery 2 to be in a standby state, at which time, the battery 2 is coupled to the load 3, such as an emergency illuminating lamp, whereupon the battery 2 continuously supplies electric power to the emergency illuminating lamp, thereby enabling the emergency illuminating lamp to emit light.

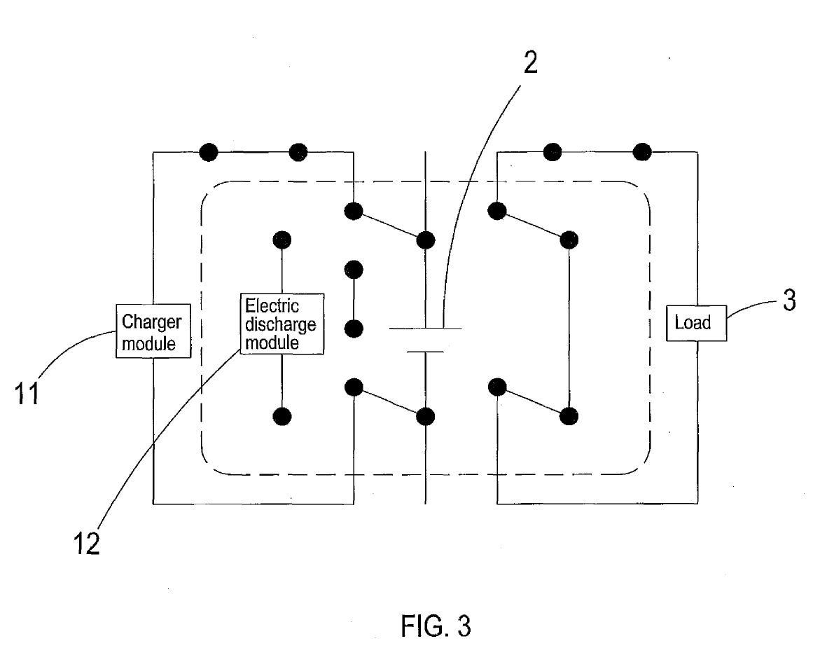

Referring together to FIG. 1 and FIG. 3, which show the block diagram and a second implementation schematic view respectively of the preferred embodiment of the present invention, and it can be clearly seen from the drawings that the embodiment depicts that the control module 13 of the present invention has assigned the battery 2 to be in a discharging mode, at which time, the battery 2 is coupled to the electric discharge module 12 to carry out discharging.

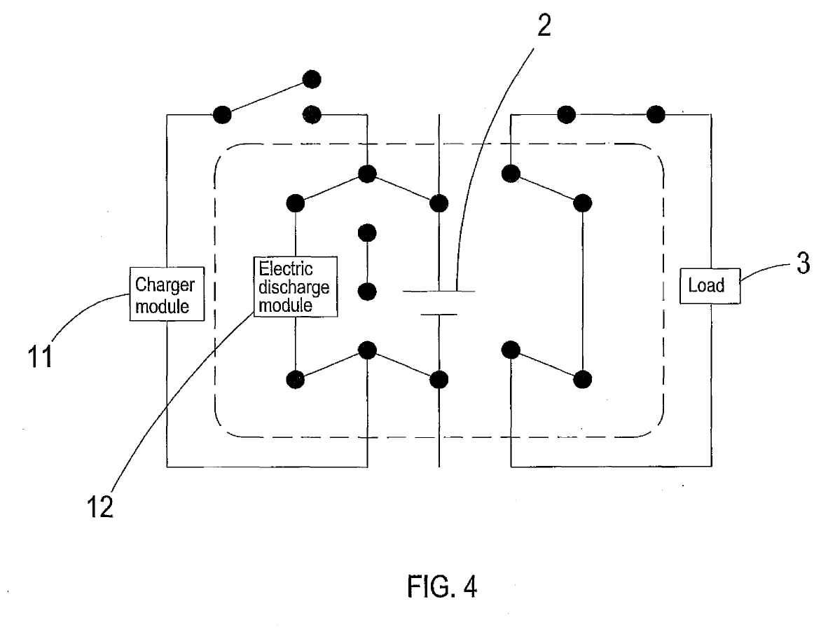

Referring together to FIG. 1 and FIG. 4, which show the block diagram and a third implementation schematic view of the preferred embodiment of the present invention, and it can be clearly seen from the drawings that the embodiment depicts that the control module 13 of the present invention has assigned the battery 2 to be in a charging mode, at which time the battery 2 is coupled to the charger module 11 and undergoing charging. Because the power supplied by the battery 2 passes through the electric discharge module 12, thus, when the electric power is completely discharged, then the battery 2 converts into a charging mode. Because the battery 2 (such as: a nickel-hydrogen battery or lithium battery) is connected to an AC supply for long periods of time undergoing continuous charging, then battery degradation problems easily result, thus, the control module 13 of the present invention can assign the battery 2 to be coupled to the charger module 11 and the electric discharge module 12 to carry out charging, discharging of the battery 2, thereby implementing activation of the battery 2.

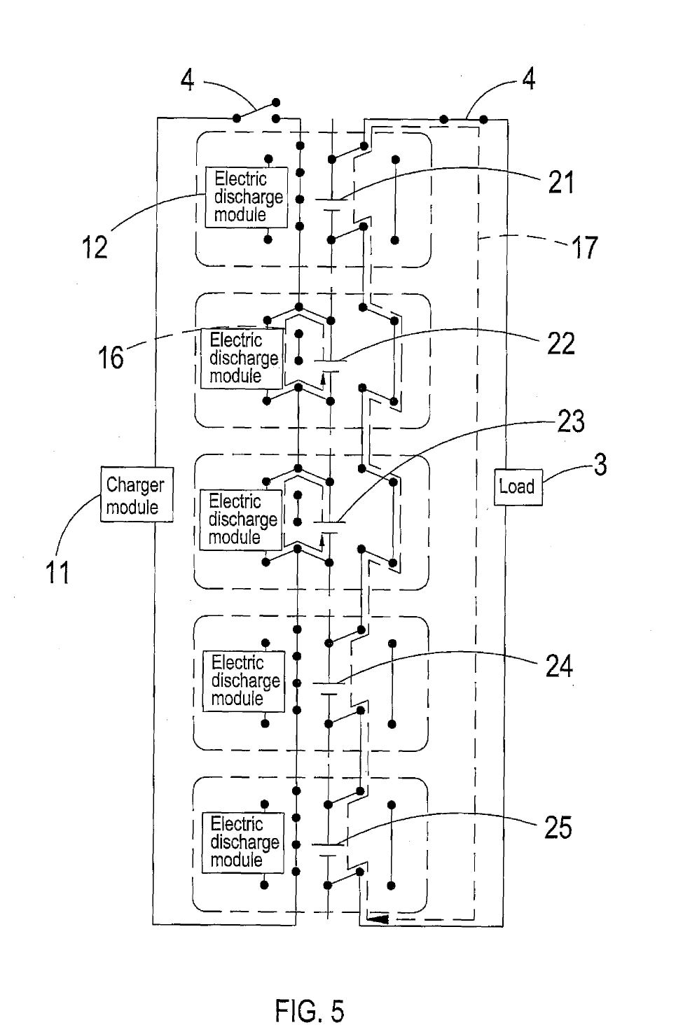

Referring together to FIG. 1 and FIG. 5, which show the block diagram and a first implementation schematic view of another preferred embodiment of the present invention, and it can be clearly seen from the drawings that when the self-maintenance battery device 1 of the present invention is coupled to a plurality of batteries 21, 22, 23, 24, 25, then the control module 13 is able to equally assign each of the batteries 21, 22, 23, 24, 25 to be in a standby state, a charging mode or a discharging mode, wherein the batteries 21, 24 and 25 are in standby states, and the batteries 21, 24 and 25 are coupled to the load 3. Moreover, the batteries 21, 24 and 25 provide electric power to the load 3 through a power supply path 17, and the batteries 22 and 23 are connected to the electric discharge modules 12, and thereby placed in discharging modes through electric discharge paths 16.

In which, switches 4 can control connection or disconnection through external circuits, and it can be clearly seen from the drawings that the switch 4 at one end is connected, thereby enabling the batteries 21, 24 and 25 to provide electric power to the load 3 through the power supply path 17, while the switch 4 at another end is disconnected, thereby enabling the batteries 22 and 23 to be connected to the electric discharge modules 12 and undergo discharging.

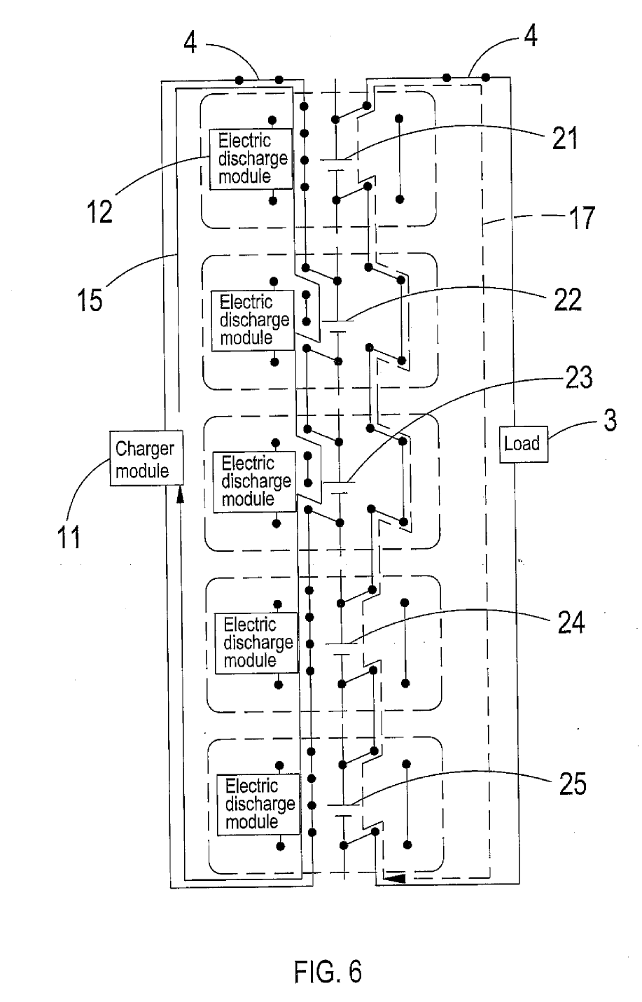

Referring together to FIG. 1 and FIG. 6, which show the block diagram and a second implementation schematic view of the other preferred embodiment of the present invention, and it can be clearly seen from the drawings that after a certain period of time, the batteries 21, 24 and 25 are equally in standby states, and the batteries 21, 24 and 25 are coupled to the load 3. Moreover, the batteries 21, 24 and 25 provide electric power to the load 3 through the power supply path 17, and the control module 13 controls the batteries 22 and 23 to change over into charging modes, whereupon the batteries 22 and 23 are coupled to the charger module 11 and charging thereof is carried out through a charging path 15.

In which, the switches 4 can control connection or disconnection through the external circuits, and it can be clearly seen from the drawings that the switches 4 at two ends are connected, thereby causing the batteries 21, 24 and 25 to be in standby states, and the batteries 22 and 23 to go into charging modes.

Accordingly, the control module 13 of the present invention is able to automatically assign the batteries 21, 22, 23, 24 and 25 to cycle through standby state, charging mode or discharging mode, and to carry out charging and discharging activation of the batteries 21, 22, 23, 24 and 25 at regular intervals without affecting the objective of supplying standby power. Hence, the serviceable life of the batteries 21, 22, 23, 24 and 25 can be prolonged, thereby reducing the number of times the batteries 21, 22, 23, 24 and 25 needs to be replaced, and further achieving the environmental protection objective.

Hence, referring to all the drawings, compared to the prior art, the following advantages exist when using the present invention:

The control module 13 of the present invention is able to assign the batteries 2, 21, 22, 23, 24, 25 to be in standby state, charging mode or discharging mode, and enables the batteries 2, 21, 22, 23, 24, 25 to change between the three states. When the batteries 2, 21, 24, 25 are in standby state, then the batteries 2, 21, 24, 25 are used to provide electric power to the load 3. When the batteries 2, 22, 23 are in charging mode, then the charger module 11 is used to couple to the batteries 2, 22, 23 to carry out charging. And when the batteries 2, 22, 23 are in discharging mode, then the electric discharge modules 12 are used to couple to the batteries 2, 22, 23 to carry out discharging thereof. Accordingly, the present invention prevents the AC power supply from continuously charging the batteries 2, 21, 22, 23, 24, 25 for long periods of time, causing degradation problems of the batteries 2, 21, 22, 23, 24, 25. The present invention enables continuous charging, discharging of the batteries 2, 21, 22, 23, 24, 25, thereby activating the batteries 2, 21, 22, 23, 24, 25, prolonging the serviceable life of the batteries 2, 21, 22, 23, 24, 25, and further achieving the environmental protection objective.

In addition, the present invention can be applied in an emergency illuminating lamp, a UPS (Uninterruptible Power Supply), a battery charger, and related equipment that must be connected to an AC power supply for long periods of time, thereby enabling continuous charging, discharging of the batteries 2, 21, 22, 23, 24, 25, while preventing the AC power supply from causing degradation problems in the batteries 2, 21, 22, 23, 24, 25 connected thereto from continuous charging for long periods of time. Moreover, the serviceable life of the batteries 2, 21, 22, 23, 24, 25 is prolonged, and the number of times the batteries 2, 21, 22, 23, 24, 25 must be replaced is reduced, thus further achieving the environmental protection objective.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A cyclic self-maintenance battery device, wherein a self-maintenance battery device is coupled to at least one battery, and the battery is coupled to a predetermined load, the self-maintenance battery device comprises:
a charger module, the charger module enables charging the batteries;
an electric discharge module, the electric discharge module enables discharging the batteries;
a control module, the control module enables assigning the batteries to be in standby state, charging mode or discharging mode; when the battery is in a standby state, then the battery is coupled to the load and provides electric power to the load, when the battery is in a charging mode, then the battery is coupled to the charger module, and the charger module is used to charge the battery, when the battery is in a discharging mode, then the battery is coupled to the electric discharge module, and the electric discharge module is used to discharge the battery.

2. The cyclic self-maintenance battery device according to claim 1, wherein the self-maintenance battery device comprises a SOH (State of Health) indication that enables detecting the state of health of the batteries.

3. The cyclic self-maintenance battery device according to claim 1, wherein the batteries are secondary batteries.
